(19) United States
(12) Patent Application Publication
(10) Pub. No.: US 2016/0236541 A1
(43) Pub. Date: Aug. 18, 2016

(54) AIR VENT

(71) Applicant: DR. SCHNEIDER KUNSTSTOFFWERKE GMBH, Kronach (DE)

(72) Inventors: Thomas Gruenbeck, Teuschnitz (DE); Reinhard Ebertsch, Steinwiesen (DE)

(21) Appl. No.: 15/028,710

(22) PCT Filed: Sep. 25, 2014
(86) PCT No.: PCT/EP2014/070537

§ 371 Date: Apr. 11, 2016

(30) Foreign Application Priority Data
Oct. 9, 2013 (DE) 10 2013 111 175.0

(51) Int. Cl. B60H 1/34; B60H 1/00

(52) U.S. Cl. CPC B60H 1/3414; B60H 1/00871; F24F 2221/28

(57) ABSTRACT

An air vent is described, having a housing with an air discharge opening, a first connection to an air supply channel and a continuous flow channel. The flow channel is curved at least at two opposite sections such that the cross-section of the flow channel increases toward the air discharge opening, and the at least two sections (26; 28) have openings (30, 32, 34), each of which opens into a chamber located behind the sections. Each chamber has a second connection, separate from the first connection, for supplying or removing air so as to generate an overpressure and/or vacuum.

The present invention relates to an air vent comprising a housing with an air outlet opening, an air supply channel and a continuous flow channel. Air vents of that kind are used, for example, in motor vehicles for the supply of air and for setting the direction of the outflowing air as well as the amount of the outflowing air.

Conventional air vents have not only vertically extending, but also horizontally extending slats, which are arranged in a flow channel. These slats can be pivoted both vertically and horizontally by way of a device so as to influence the direction of the outflowing air. Air vents of that kind usually have a rectangular or round cross-section.

In addition, air vents with a substantially round cross-section are known. These can similarly have slats, wherein the slats are often mounted in a ring and the direction of the outflowing air is produced by rotation of the ring and pivotation of the slats mounted therein.

Moreover, air vents are known from the prior art which comprise means forming a separation edge for an air flow. DE 10 2010 049 110 A1 discloses an air distributing device for a motor vehicle. The air distributing device has an air outflow opening and an air guide element, by way of which the air outflow direction of an air jet issuing from this air outflow opening can be changed. The air guide element is periodically pivotably movable by way of drive elements, wherein the air guide element is constructed as an inner component of the air guide device. The air guide device additionally has a baffle wall, which is opposite a blocking flap in the flow cross-section of the air channel and is arranged to be displaced in flow direction upstream with respect to the blocking flap. The lateral deflection, which is produced by the opened blocking flap, of an air jet is assisted by a vacuum arising in the downstream region of this baffle wall.

DE 100 63 189 B4 discloses a ventilating device with a channel which is flowed through by air in one direction and which has an air outlet opening and—within the channel—controllable air guide elements, which are opposite one another in paired arrangement, for deflection of the air flow. A first air guide element for deflection of the air flow is formed in direction away from the channel wall and a second air guide element, which is opposite the first air guide element, for deflecting the air flow is formed in direction towards the channel wall. The air guide elements in the channel wall are mounted to adjoin the channel wall and the second air guide element is constructed for deflection of the air flow on the basis of Coanda effect. For this purpose, the second air guide element is arranged to be offset relative to the first air guide element in channel length direction towards the channel interior, as a result of which a region of sub-atmospheric pressure is formed downstream at the channel wall.

DE 34 37 259 C2 discloses a ventilating device with a plurality of mutually adjacent slats utilising a so-called Coanda effect. The slats are arranged in stationary position in a ventilating channel along a fixedly locked curve and mounted to be rotatable. They are controlled in such a way that each slat adopts a different angle with respect to the incident air. For setting a large outflow angle, one half of the air nozzles is so closed by the slats lying in this half that the slats form a convexly cambered curve. As a consequence of Coanda effect, the air flow is conducted along this convex curve and correspondingly deflected.

JP S54 108323 A discloses an air vent which is arranged at a vehicle roof and provides air pulsation. In order to provide the air pulsation, two curved regions are provided which increase the cross-section of an air channel to an air outlet section, wherein the cross-section of the air channel is reduced by an air supply channel. For this purpose, boundary walls facing the air supply channel are arranged normal to the air supply channel. The boundary walls additionally protrude further into the air supply channel than the curved regions, which are arranged at a spacing therefrom, in the air channel. A spacing is present between the boundary walls and the curved regions, wherein air is supplied in alternation to these thus-formed regions.

U.S. Pat. No. 4,989,807 A discloses an S-shaped power-plant intake diffusor, wherein a deflecting plate and an opening are provided in the diffusor. Air can be inducted or supplied by way of the opening.

The disadvantage with the air vents known from the prior art resides in the use of slats or other deflecting means which have to be moved. Movement of components of a device always has the risk that failure or disturbance can occur due to damage or failure of components of these devices. Thus, for example, slats could jam after frequent pivotation or the setting means, which are often mounted on a so-called control slat, could be moved only with difficulty.

However, air vents have to be simple to operate and without susceptibility to disturbances. In addition, it is desired for air vents to have a visually pleasant appearance. Various coatings for slats have indeed been indicated in the prior art, but the appearance of a ‘ventilation grill’, having horizontally and vertically extending slats, is perceived as unattractive particularly in motor vehicles.

It is therefore the object of the present invention to indicate an air vent which has a simple construction without components susceptible to fault and in addition offers a visually pleasing appearance.

According to the invention the object is fulfilled by an air vent with the technical features indicated in claim 1.

Advantageous developments of the invention are indicated in detail in the subclaims.

An air vent according to the invention comprises a housing with an air outlet opening, a first connection to an air supply channel and a continuous flow channel, wherein the flow channel is constructed to be so curved at at least two opposite sections that the cross-section of the flow channel increases towards the air outlet opening and the at least two sections each have openings which each open into a chamber lying behind the sections, wherein the chambers each have a second connection, which is separated from the first connection, for supply or removal of air for generating overpressure and/or vacuum and wherein the sections have a plurality of rows of openings.

In the air vent according to the invention fresh air or air from an air-conditioning installation is conducted through the flow channel via the first connection from an air supply channel. The flow channel is so constructed that the air flows out of the air outlet opening at and along the curved sections and the flow produced by the curved shape is maintained due to Coanda effect, an that the air flow is deflected. In order to produce a setting of the air outflow direction, air is supplied to or removed from the chambers, which are located behind the sections, by way of the second connections, wherein overpressure regions and/or sub-atmospheric pressure regions arise in the sections. These overpressure and/or sub-atmospheric pressure regions produce a change in the direction of the outflowing air. Thus, through producing an overpressure in the two opposite sections a substantially rectilinear air flow from the air vent is set. If a vacuum is produced in the two opposite chambers of the sections, then the air is more strongly deflected so that a more diffuse air flow arises. If in the case of two opposite chambers an overpressure is produced in one chamber and a vacuum in the other chamber then deflection of the air flow in the direction of the section having the chamber in which the vacuum is produced takes place.

The air vent according to the invention does not have in the viewing region any mechanical air guide elements producing a change in the direction of the outflowing air. A visually pleasing appearance and a substantial degree of design freedom thereby result. In addition, an air vent of that kind needs less room than conventional air vents, which apart from the slats additionally have devices for simultaneous pivotation of a group of slats (for example, coupling rod) and mechanical setting means for pivoting the slats. In the case of the present invention the air intended for outflow is supplied by way of the air feed shaft. The change in outflow direction takes place by way of the second connections and air supply and air removal from the respective chambers of the curved sections. Means can be provided for setting the deflection of the air flowing out of the air vent, which means produce—mechanically, electrically or in another way—the air supply to and air removal from the chambers for setting the air outflow direction. However, there are no components, which additionally cause undesired turbulence, protruding into the air feed shaft, the continuous flow channel and the air outlet opening. Setting of the outflowing air takes place only by additional introduction of air through the openings of a chamber (overpressure) or by suction of the outflowing air through the openings of a chamber (vacuum). Due to the formation of overpressure or vacuum in the chambers and the curved configuration of the sections through utilisation of Coanda effect, a simple construction, which is not susceptible to disturbance, of an air vent is provided.

In order to supply or remove the air by way of the second connections of the chambers a device which blows in or sucks air in the sense of a compressor or a pump can be provided. Depending on the curvature of the sections as well as the cross-section of the flow channel, various deflections of the outflowing air can be set. Moreover, the degree of deflection of the outflowing air can be proportionally influenced by way of the setting of the vacuum or overpressure.

The air vent as well as the supply and removal of the air for producing overpressure and vacuum can be controlled by way of mechanical setting means (for example, joystick) or input by way of a display.

The housing of the air vent can also have four curved sections with openings, wherein in each instance two sections are mutually opposite and the four sections substantially form a flow channel which is rectangular in cross-section and each section has a separate chamber with a second connection for the supply or removal of air. Through the four curved sections the air can be deflected not only horizontally, but also vertically in both directions, and in addition horizontally and vertically deflected. For example, two mutually adjoining sections can be acted on by an overpressure and the other two sections acted on by a vacuum, so that an outflow direction downwardly and in a lateral direction arises. Depending on the intensity of the overpressure which is formed in the two overpressure chambers it is possible for one direction to be set more strongly than the other. For that purpose, there is produced by way of the second connections of these chambers an overpressure which is not in the same proportion, but is dependent on the desired outflow direction of the air. The same applies to formation of the vacuum by way of the corresponding chambers of the sections.

The openings can have an increasingly larger diameter in direction towards the air outlet opening. Deflection of the outflowing air is thereby improved. The sections can have several rows of openings. For example, a first row is arranged directly after the air supply channel and further rows following thereon extend in the direction of the air outflow opening, in which case the diameter of the openings increases with each row in direction towards the air outlet opening.

The openings can have, for example, a cross-section which is round, polygonal, oval or also any other form. Moreover, the size of the openings is to be dimensioned in dependence on the dimensioning of the air vent as well as the degree of deflection.

In particular, in further forms of embodiment of the air vent the sections can have a convex curvature. A convex curvature provides, for example, a diffuse air supply in the case of an outflowing air flow without formation of an overpressure or a vacuum in the chambers.

In further forms of embodiment the openings have a substantially round cross-section.

The flow channel can also have an even number of sections with openings which form a flow channel substantially round in cross-section, wherein each section has a separate chamber with a second connection for supply or removal of air. Beyond that, it is possible to provide all cross-sectional shapes for the flow channel. Appropriate sections with chambers lying therebehind are then to be provided in correspondence with the selected cross-sectional shapes. It is also possible, for example, for an uneven number of sections and thus an uneven number of chambers to be formed. In that regard it is important that each chamber has a separate second connection for the supply or removal of air.

The air vent can have a surround which surrounds the air outlet opening and which has in the region adjoining the air outlet opening a curvature corresponding with the sections. As a result, the deflection of the outflowing air is not obstructed by the surround, but instead assisted.

Moreover, the flow channel and the air supply channel can be no constructed that the flow channel and the air supply channel have substantially the same cross-section in the region of the first connection. This ensures that the outflowing air is not subjected to undesired deflection or turbulence by cross-sectional changes or edges such as would impair setting of the direction of the outflowing air.

In further forms of embodiment of the air vent the air supply channel has in front of the first connection at least one path which provides a substantially rectilinear air flow in the flow channel. This measure similarly serves the purpose of not negatively influencing deflection of the outflowing air.

The separate feed of air to the chambers of the sections by way of the second connections can be set and changed by way of a control. Control can, for example, be carried out mechanically by way of a control component, which is coupled with further means for supply and removal of the air with respect to the second connections, or electrically.

In further forms of embodiment the sections of the flow channel with the openings consist of a flexible material. The flexible material additionally enables easy deformation so that in the case of producing an overpressure in a chamber the section is urged by a defined amount into the flow channel, whereby a stronger degree of curvature and thus a stronger degree of deflection of the outflowing air arise. Moreover, through formation of the sections from a flexible material it is possible, when a vacuum is produced in a chamber, for deformation of this section to take place by a defined amount in the direction of the chamber so that as a result the deflection of the outflowing air can also be influenced.

The air vent as well as the housing of the air vent can, in further embodiments, consist of plastics material. Particularly suitable for that purpose are plastics which are appropriate for injection-moulding of the components of the air vent and have the required properties corresponding with the intended use of the air vent.

The second connections of the chambers can be connected at the rear side, which is remote from the air outlet opening, with a device for supply and/or removal of air for producing an overpressure and/or a vacuum in the chambers, for example the device is a compressor or a pump which extracts air from or feeds air to the chambers, wherein in addition the device can be coupled with a valve or with a plurality of valves which control the supply and removal of the air. For that purpose, an electrical and/or a software-based control can be included, which controls opening and closing of the valves, the amount of the overpressure or vacuum produced and the operation of the device (for example compressor and/or pump).

Moreover, setting means in accordance with which the direction, deflection and/or amount of outflowing air can be controlled can be arranged at a surround surrounding the air outlet opening. The setting means can control the direction, deflection and/or amount of outflowing air mechanically, as already indicated in the foregoing. However, beyond that the setting means can also electrically control a directional change, deflection and/or quantity regulation of the outflowing air.

Moreover, a closure device can be provided in the air supply channel, the closure device being constructed to allow or prevent air supply in the flow channel and to regulate the quantity of the supplied air. Closure devices of that kind are also termed, for example, throttle flaps.

In that regard, the closure device can be controllable by way of setting means arranged at a surround surrounding the air outlet opening. Thus, the closure device can, for example, be coupled with the setting means or a further means has the functionalities of the setting means and the closure device. The closure device can be controlled by way of the setting means electrically, mechanically or in another way.

Furthermore, the air supply to and air removal from the chambers can be regulated in the air vent, wherein in that regard the air supply and air removal are controllable so that apart from the supply and removal of air for producing an overpressure or a vacuum the strength of the pressure or overpressure and vacuum can also be controlled.

In further forms of embodiment the chambers are divided into at least two sub-chambers and either each have a separate second connection or at least one separating means, by way of which the volume of the thus-formed sub-chambers can be varied. As a result, an even finer setting of the outflowing air can be achieved. Alternatively, the respective individual sections can have a plurality of chambers which each have a separate second connection or are variable in the volume thereof by way of separating means.

Further features, design features and developments of the invention are evident from the following non-limiting description of the figures.

The embodiments shown in the figures have exemplifying character and are therefore not to be understood as limiting and can, in the case of forms of embodiment to be implemented, differ from the illustration.

In the drawings:

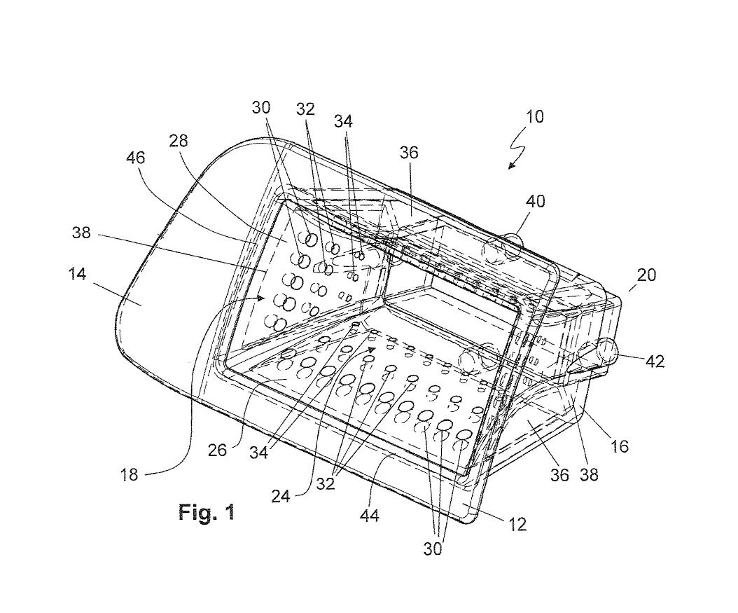

FIG. 1 shows a schematic illustration of an air vent in perspective view;

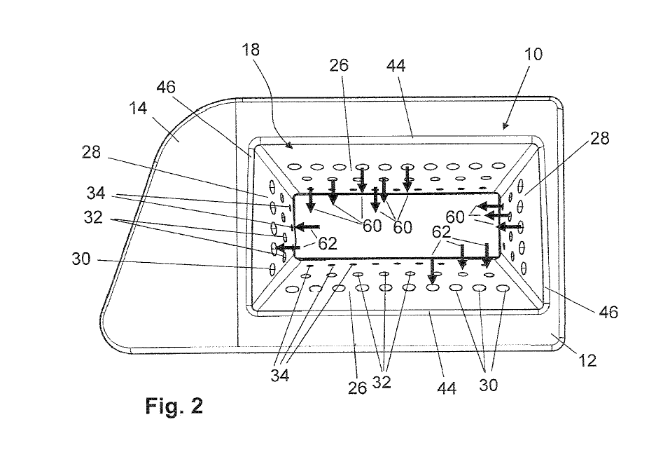

FIG. 2 shows a schematic illustration of an air vent in viewing direction onto an air outlet opening;

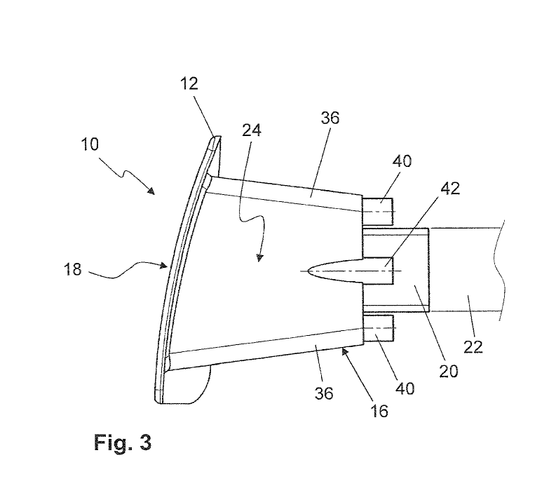

FIG. 3 shows a schematic illustration of an air vent in a side view;

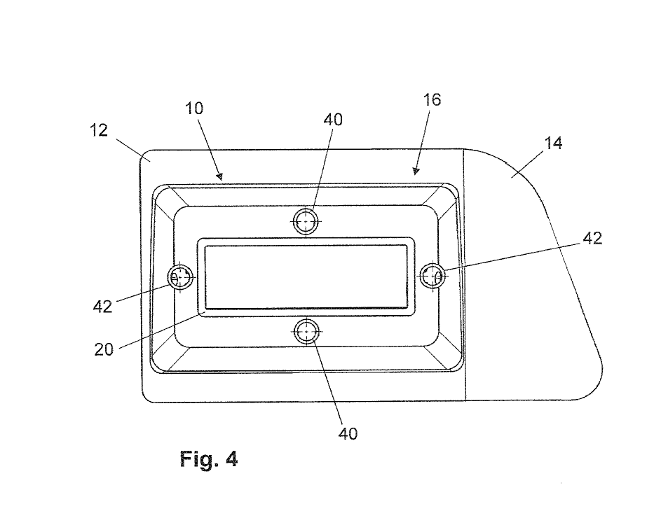

FIG. 4 shows a schematic illustration of an air vent in viewing direction onto a connection for an air supply channel;

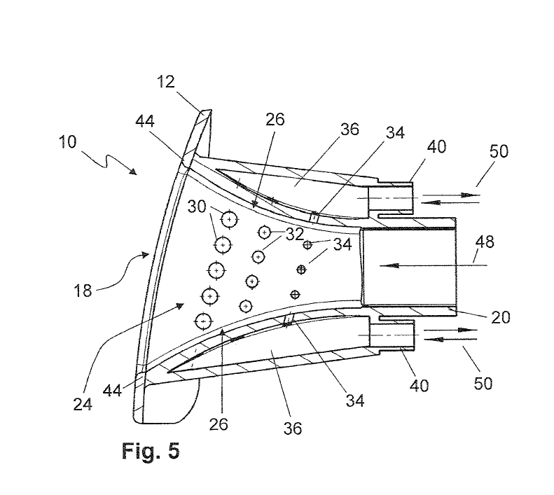

FIG. 5 shows a schematic partly sectional illustration of an air vent in a side view; and

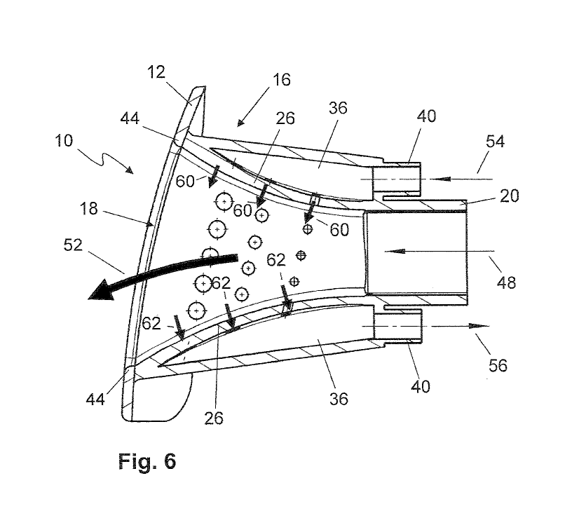

FIG. 6 shows a further schematic partly sectional illustration of an air vent in a side view.

In the figures, parts provided with the same reference numerals substantially correspond with one another in the construction and function thereof.

FIG. 1 shows a schematic illustration of an air vent 10 in a perspective view, the components of the air vent 10 being illustrated schematically.

The air vent 10 has a housing 16. A surround 12 is arranged at the housing 16 at a front air outlet opening 18, wherein the opening of the surround 12 substantially corresponds with the air outlet opening 18 of the air vent 10. In addition, a surround connection 14 is mounted on the surround 12. A surround surrounding the air outlet opening 18 preferably consists of the surround 12 and the surround connection 14, the illustration shown in FIG. 1 being only by way of example. Thus, a surround can, for example, extend over an entire dashboard or the cladding element of the dashboard and form a surround with at least one opening for an air vent 10.

The housing 16 of the air vent 10 has a first connection 20, which is connected with an air supply channel 22 (not illustrated in FIG. 1). The first connection 20 has a substantially rectangular cross-section and is connected with a flow channel 24 of the air vent 10. The flow channel 24 has a diameter substantially corresponding with the first connection 20 in the connection region at the first connection 20. The diameter of the flow channel 24 increases in direction towards the air outlet opening 18. The flow channel 24 has four sections 26 and 28, wherein in each instance two sections 26 and 28 are opposite one another and the flow channel 24 is surrounded by the four sections 26 and 28 and defined by the sections 26 and 28.

The sections 26 and 28 additionally have openings 30, 32 and 34. In FIG. 1 only some of the openings 30, 32 and 34 are indicated, but the other openings, which are not designated, correspond with the designated openings 30, 32 and 34 in the respective rows.

The section 26 has, as shown, three rows of openings 30, 32 and 34, wherein the diameter of the openings 30, 32 and 34 starting from the connecting region of the flow channel 24 with the first connection 20 increases towards the air outlet opening 18.

Each of the sections 26 and 28 has a chamber 26 and 38 therebehind. A connection between the chambers 36, 38 and the flow channel 24 is present by way of the openings 30, 32 and 34. The chambers 36 and 38 each have a second connection 40 and 42. The two opposite chambers 36 of the sections 26 (in FIG. 1 only the lower section 26 is illustrated) each have a separate second connection 40 and the chambers 38 of the sections 28 each have a second connection 42. Air can be supplied or removed by way of the second connections 40 and 42 for generation of an overpressure or a vacuum in the corresponding chambers 36 and 38 as well as in the regions of the sections 26 and 28 with the openings 30, 32 and 34.

The sections 26 and 28 are formed to be curved and have a convex curvature, wherein the cross-section of the flow channel 24 increases with increasing spacing from the first connection 20. Correspondingly, the openings 30, 32 and 34 are also no formed that the diameter thereof increases in dependence on the increasing cross-section of the flow channel 24. The convex curvature of the sections 26 and 28 has the effect that air supplied by the air supply channel 22 flows along the surface of the sections 26 and 28 due to so-called Coanda effect and is thus deflected to a specific extent. In order to influence the deflection of the outflowing air in desired manner, air is supplied to or removed from the second connections 40 and 42 no that, for example, air flows from the lower section 26 out of the openings 30, 32 and 34 and thus produces a deflection of the exiting air flow upwardly in the direction of the opposite section 26.

The air supplied or removed by way of the second connections 40 and 42 is adjusted by way of a further device. The air flow, which is supplied by way of the air supply channel 22 to the air vent 10, does not influence the air supplied to or air removed from the chambers 36 and 38 by way of the connections 40 and 42. Consequently, there is an air flow by way of the air supply channel 22—as already known from slat flows from the prior art—and additionally a so-called control air flow, which, for example, is selectively supplied to the connections 40 and 42 by a compressor via a valve or switching means.

In addition, air can also be removed by way of a compressor or a further device via the chambers 36 and 38. Accordingly, air of the outflowing air flow is extracted by way of the openings 30, 32 and 34 by formation of sub-atmospheric regions in the corresponding chambers 36 and 38 and the regions of the sections 26 and 28 with the openings 30, 32 and 34.

In order to control the outflowing air flow a control element (not illustrated) can be provided at the surround connection 14, which element mechanically produces the supply of air to the chambers 36 and 38 or removal of air from the chambers 36 and 38. However, the control can also be carried out electrically so that actuation of the control means regulates a corresponding action by a device for supplying and removing the air. A device of that kind can, however, also be controlled via a display of a motor vehicle, by way of which all settings, for example also those of an air conditioning installation, can be set.

The air vent 10 illustrated in FIG. 1 produces, by the selective removal of air by way of the second connections 40 and 42 from the chambers 36 and 38, a control of the outflowing air flow. In addition, the air supply channel 22 can comprise a throttle flap or other closure devices which, as described in the foregoing, is or are similarly controlled and sets or set the amount of outflowing air from the air vent 10 and can also completely prevent outflow. In addition, the amount of the air supplied to or removed from the chambers 36 and 38 can also be controlled by way of further means and devices so that the degree of deflection can also be controlled by way of those.

FIG. 2 shows a schematic illustration of an air vent 10 in viewing direction onto an air outlet opening 18. In this illustration a surround 12, a surround connection 14, radiused regions 44 and 46 of the surround 12 and in each instance two mutually opposite sections 26 and 28 of the air vent 10 are illustrated. The sections 26 and 28 each have three rows of openings 30, 32 and 34. The diameter of the openings 30, 32 and 34 increases, with increasing distance from the air outlet opening 18, towards the air supply channel 22. The air vent 10 of FIG. 2 illustrates a plan view of the air vent 10 of FIG. 1. The sections 26 and 28 are therefore formed to be curved and the regions 44 and 46 of the surround 12 have a corresponding curvature, so that the outflowing air flow is not deflected or swirled by thus-formed deflecting edges and on that deflection by the curved sections 26 and 28 is continued through utilisation of Coanda effect.

In order to avoid turbulence of the air flow, transitions between the individual sections 26 and 28 are in addition formed to be radiused.

FIG. 2 additionally shows how the deflection of an issuing air flow for deflection in the viewing direction of FIG. 2 downwardly and to the lefthand side can take place. For that purpose, air is introduced into or removed from the chambers 36 and 38 for producing overpressure and sub-atmospheric pressure regions by way of the connections 40 and 42 (not illustrated in FIG. 2). This is schematically indicated by the arrows 60, which illustrate outflowing air from the openings 30, 32 and 34. Obviously, the air flows not only out of the designated openings 30, 32 and 34, but also out of all openings 30, 32 and 34 associated with a chamber. Correspondingly, the air, as indicated by the arrows 62, is also removed from the chambers 36 and 38 through all openings 30, 32 and 34.

It is apparent from the illustration of FIG. 2 that apart from utilisation of Coanda effect for deflection of the issuing air flow from the air outlet opening 18, the introduction of air and the removal of air influence the air flow in the desired manner. The degree of deflection can additionally be set by the amount of the outflowing and removed air. However, in distinction from the illustration in FIG. 2, by way of example the two opposite regions 26 and the righthand section 28 can also serve for formation of overpressure regions through introduction of air via the openings 30, 32 and 34, wherein through additional formation of a sub-atmospheric pressure region on the lefthand side in the lefthand section 28 a deflection of an issuing air flow to the left results. The four illustrated sections 26 and 28 can be controlled independently of one another so that not only the supply or removal of air, but also the degree of supply or removal of air is settable for each chamber 36 and 38 by the second connections 40 and 42 independently of one another.

FIG. 3 shows a schematic illustration of an air vent 10 in a side view. The air vent 10 illustrated in FIG. 3 is a side view of the air vent 10 shown in FIGS. 1 and 2. An air supply channel 22, which is connected with the first connection 20 of the air vent 10, is schematically illustrated in FIG. 3. In addition, the two second connections 40 to an upper chamber 36 and a lower chamber 36 as well as a second connection 42 to a chamber 38 are illustrated. The second connections 40 and 42 are, for example, connected with a hose which leads to a valve of a further device which controls the supply and removal of air to and from the respective second connections 40 and 42 for producing overpressure and sub-atmospheric pressure in the chambers 36 and 38 and the regions of the sections 26 and 28 with the openings 30, 32 and 34.

The chambers 36 are schematically indicated in FIG. 3. The chambers 36 therefore do not have a straight section, such as appears in FIG. 3, but have internal (in the housing 16) convexly curved sections 26 and 28.

FIG. 4 shows a schematic illustration of an air vent 10 with a view onto a connection 20 for an air supply channel 22. The rear view of an air vent 10 of FIG. 4 shows the air vent 10, which is already shown with respect to FIGS. 1 to 3, with a view of the first connection 20 and the second connections 40 and 42.

FIG. 5 shows a schematic partly sectional illustration of an air vent 10 in a side view. The air vent 10 illustrated in FIG. 5 shows a sectional view, wherein the air vent 10 shows an illustration of the air vent 10 shown in FIGS. 1 to 4.

The convex curvature of the sections 26 is shown in FIG. 5. The sections 28 have a corresponding curvature, but the curvature thereof is not apparent in FIG. 5. The regions 44 of the surround 12, which bound the air outlet opening 18, are radiused. However, in departure from the illustration in FIG. 5 an exact continuation of the convex curvature of the sections 26 and correspondingly a continuation of the convex curvature of the sections 44 and 46 can be provided by the regions 46.

The openings 30, 32 and 34 of a section 28 are illustrated in FIG. 5. The three illustrated rows with the openings 30, 32 and 34 do not extend, in the viewing direction of FIG. 5, along a vertical line, but are formed substantially parallel to a boundary edge by the surround 12. In that regard. FIG. 5 clearly shows that the diameter of the openings 30, 32 and 34 increases towards the air exit opening 18 starting from the first connection 20.

Air is supplied (illustrated by arrow 48) to the air vent 10 by way of an air supply channel 22 (not illustrated) and air is separately supplied and removed (illustrated by the arrows 50) by way of the second connections 40 so as to deflect the issuing air flow in the desired direction.

The design of an air vent 10, as shown in the figures, has the advantage that no components for deflecting the air flow protrude into the flow channel, so that there is also a reduction in disturbing noises which occur in conventional air vents due to the components protruding into the flow channel, and there is no creation of turbulence in the outflowing air.

It is additionally apparent through FIG. 5 that the air supplied to or removed from the chambers 36 and in corresponding manner to or from the chambers 38 takes place by way of the openings 30, 32 and 34.

FIG. 6 shows a further schematic partly sectional illustration of an air vent 10 in a side view. This side view shows, in one embodiment, how an air flow can be deflected downwardly. The air vent 10 of FIG. 6 is a sectional view of the air vent 10 already described and illustrated with respect to FIGS. 1 to 5. In order to downwardly deflect (illustrated by arrow 52) the air flow (illustrated by arrow 48) from the air outlet opening 18 air is supplied (illustrated by arrow 54) to the upper chamber 36 by way of the second connection 40.

For that purpose, air is removed (illustrated by arrow 56) from the lower chamber 36 by way of the second connection 40. In that case, an overpressure region arises in the upper chamber 36 as well as the section 26 with the openings 30, 32 and 34 and a sub-atmospheric pressure region arises in the lower chamber 36 as well as the section 26 with the openings 30, 32 and 34. It is indicated by way of the arrows 60 and 62 how the influencing of the outflowing air flow by supply of air to or removal of air from the chambers 36 (and correspondingly 38) can take place.

The air vent 10 illustrated and described in the description of the figures is suitable for the purpose of deflecting as desired—without noise and without a multiplicity of setting means arranged in a flow channel—an air flow by way of Coanda effect through the curved construction of the sections 26 and 28 and the generation of overpressure and sub-atmospheric pressure regions in the chambers 36 and 38 as well as the sections 26 and 28 with the openings 30, 32 and 34.

### REFERENCE NUMERAL LIST

10 air vent
12 surround
14 surround connection
16 housing
18 air outlet opening
20 first connection
22 air supply channel
24 flow channel
26 section
28 section
30 opening
32 opening
34 opening
36 chamber
38 chamber
40 second connection
42 second connection
44 region
46 region
48 arrow
50 arrow
52 arrow
54 arrow
56 arrow
60 arrow
62 arrow

1-19. (canceled)

20. An air vent comprising a housing with an air outlet opening, a first connection to an air supply channel and a continuous flow channel, wherein the flow channel is formed to be so curved at at least two opposite sections that the cross-section of the flow channel increases towards the air outlet opening, and the at least two sections each have openings which each open into a respective chamber lying behind the sections, and wherein the chambers each have a second connection, which is separated from the first connection, for supplying or removing air so as to generate an overpressure and/or a vacuum.

21. The air vent according to claim 20, wherein the housing has four curved sections with openings, wherein each two sections are opposite one another and the four sections form a flow channel of rectangular cross-section, each section having a separate chamber with a second connection for the supply or removal of air.

22. The air vent according to claim 20, wherein the openings have an increasingly greater diameter in direction towards the air outlet opening.

23. The air vent according to claim 20, wherein the sections have a plurality of rows of openings.

24. The air vent according to claim 20, wherein the sections have a convex curvature.

25. The air vent according to claim 20, wherein the openings have a round cross-section.

26. The air vent according to claim 20, wherein the flow channel has an even number of sections with openings, which form a flow channel of round cross-section, each section having a separate chamber with a second connection for the supply or removal of air.

27. The air vent according to claim 20, comprising a surround, which surrounds the air outlet opening and which in the regions adjoining the air outlet opening has a curvature corresponding with the sections.

28. The air vent according to claim 20, wherein the flow channel and the air feed channel have the same cross-section in the region of the first connection.

29. The air vent according to claim 20, wherein the air supply channel has in front of the first connection at least one path providing rectilinear air flow in the flow channel.

30. The air vent according to claim 20, wherein the separate supply of air to the chambers of the sections by way of the second connections is settable and variable via a control.

31. The air vent according to claim 20, wherein the sections of the flow channel with the openings consist of a flexible material.

32. The air vent according to claim 20, wherein the air vent consists of plastics material.

33. The air vent according to claim 20, wherein the second connections of the chambers are connectable at the rear side remote from the air outlet opening with a device for supplying and/or removing air for generating an overpressure and/or a vacuum in the chambers.

34. The air vent according to claim 20, wherein a setting device in accordance with which the direction, deflection and/or amount of outflowing air is or are controllable are arranged at a surround surrounding the air outlet opening.

35. The air vent according to claim 20, wherein a closure device constructed to allow or prevent air supply to the flow channel and to regulate the amount of supplied air is provided in the air supply channel.

36. The air vent according to claim 35, wherein the closure device is controllable by way of setting device arranged at a surround surrounding the air outlet opening.

37. The air vent according to claim 20, wherein the air supply to and the air removal from the chambers can be regulated.

38. The air vent according to claim 20, wherein the chambers are divided into at least two sub-chambers and either each have a separate second connection or each have at least one separating device by way of which the volume of the thus-formed sub-chambers is variable.
